(19) United States
(12) Patent Application Publication
(10) Pub. No.: US 2011/0051578 A1
(43) Pub. Date: Mar. 3, 2011

(54) METHOD FOR TESTING OPTICAL DISK DRIVE

(76) Inventors: Chun-Wen Lai, Taoyuan County (TW); Chi-Hsiang Kuo, Taoyuan County (TW)

(21) Appl. No.: 12/870,841

(22) Filed: Aug. 29, 2010

(30) Foreign Application Priority Data
Sep. 2, 2009 (TW) 098129651

(51) Int. Cl. G11B 7/00

(52) U.S. Cl. 369/53.31; G9B/7

(57) ABSTRACT

The invention provides a method for testing an optical disk drive. The method comprises: resetting a successful number of a test and setting an upper limit for the successful number of the test; proceeding with a virtual writing by a laser beam with predetermined power; checking whether the output power is different from the predetermined power; if the output power is different from the predetermined power, determine the test fails, and if the output power is not different from the predetermined power, plus one to the successful number, wherein the optical disk drive passes the test when the number of successful test reaches the upper limit. The invention can reduce the time of testing the optical disk drive.

### BACKGROUND OF THE INVENTION

1. Field of the Invention

The invention relates to a method for testing an optical disk drive, and more particularly, to a testing method for checking an optical disk drive lifetime by utilizing optical disk writing times of the optical disk drive.

2. Description of the Prior Art

To ensure quality and stability of an optical disc drive, the optical disc drive must be tested before leaving the factory. The test repeatedly writes data in an optical disc and checks the writing result to determine whether the optical disc drive is normal, and lifetime of the optical disc drive.

FIG. 1 is block diagram of an optical disc drive during a test according to the prior art disclosed by R.O.C. patent application serial number 095146141. The prior art performs a test for an optical disc drive 1 which can read and write repeatedly. The test process firstly set an optical disc drive test disk mode for a rewritable optical disc 2 (such as CD, DVD, or BD). The prior art uses a micro processor 3 to rest a counter 4 and set an upper limit for a successful number of the test. The micro processor 3 moves an optical pickup head 5 to an initial position of an inner track of the optical disc 2, and controls the focus serving unit 6 and the laser driving unit 7 to drive the optical pickup head 5 to output a laser beam with a writing power and focus on a data layer 8 of the optical disc 2. Next, the micro processor 3 controls a track serving unit 9 to move the optical pickup head 5 to write data from the inner track to an outer track along the data track of the optical disc 2. After finishing the writing process, the micro processor 3 controls the optical pickup head 5 to read data marks written in the optical disc 2 along the data track of the optical disc 2, and decode the data marks to be data signals.

Next, compare the read data with the original written data to determine whether the writing process is success. If the data is not written in the optical disc successfully, then the optical disc drive does not pass the lifetime test, and determine the test fails and end the test; if the data is written in the optical disc 2 successfully, the micro processor 3 controls the counter 4 to plus one to the successful number, and then checks whether the successful number reaches the upper limit. If the successful number does not reach the upper limit, the micro processor 3 controls the laser driving unit 7 to drive the optical pickup head 5 to output a laser beam with a removing power to remove the data written in the optical disc 2, and return to the initial position of the inner track of the optical disc 2; if the successful number reaches the upper limit, determine the optical disc drive passes the lifetime test, and end the test.

However, the prior art uses a rewritable optical disc to test the optical disc drive to reduce consumption of the optical disc, and the prior art has to focus on the data layer 8 of the optical disc 2 to write, read data, determine whether the writing is successful, and remove data during each test process, and the prior art requires a lot of test time and makes test efficiency lower and increases fabricating time of the optical disc drive. The prior art only can test the optical disc drive with writing function, but can not test other kinds of optical disc drives. Thus, the prior art still has problems to be solved.

### SUMMARY OF THE INVENTION

One objective of the present invention is to provide a method for testing an optical disk drive, which can directly determine whether the optical disk drive passes a test by detecting a power variance of a laser beam of an optical pickup head to simplify the test procedure, so as to reduce the test time.

Another objective of the present invention is to provide a method for testing an optical disk drive, which makes a focus of the laser beam of an optical pickup head offset from a data layer or a label layer of an optical disk to avoid writing the optical disk, so as to reduce wear of the optical disk.

Another objective of the present invention is to provide a method for testing an optical disk drive, which can test various kinds of optical disk drive, so as to increase applicable field of test.

To achieve the abovementioned objectives, the present invention provides a method for testing an optical disk drive, comprising: resetting a successful number of a test and setting an upper limit for the successful number of the test; proceeding with a virtual writing by a laser beam with predetermined power, wherein a focus of the laser beam of an optical pickup head is offset from a data layer or a label layer of an optical disk; detecting the output power; checking whether the output power is different from the predetermined power; if the output power is different from the predetermined power, determine the test fails, and if the output power is not different from the predetermined power, plus one to the successful number, wherein the optical disk drive passes the test when the number of successful test reaches the upper limit.

These and other objectives of the present invention will no doubt become obvious to those of ordinary skill in the art after reading the following detailed description of the preferred embodiment that is illustrated in the various Figures and drawings.

### BRIEF DESCRIPTION OF THE DRAWINGS

FIG. 1 is a block diagram of an optical disc drive during a test according to the prior art.

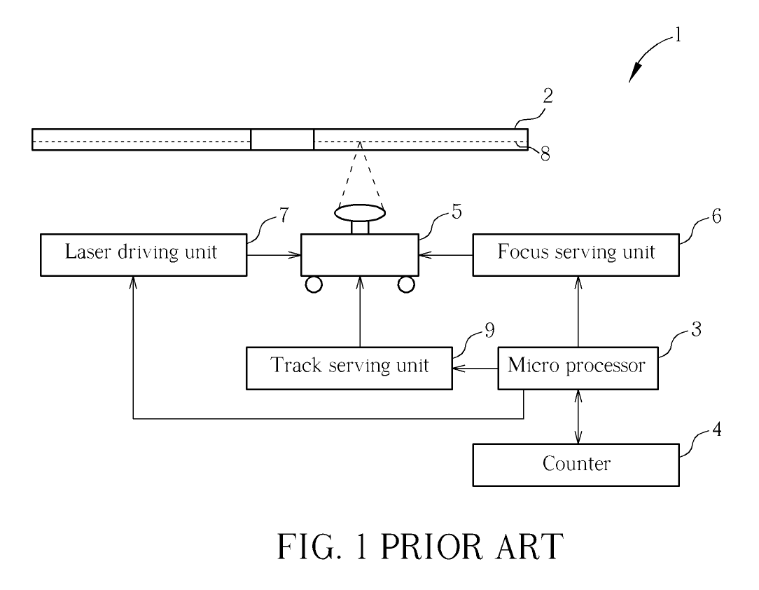

FIG. 2 is a block diagram of an optical disc drive during a test according to the present invention.

FIG. 3 is a diagram of the predetermined focus level of the test according to the present invention.

FIG. 4 is a flowchart of a method for testing an optical disk drive according to the present invention.

### DETAILED DESCRIPTION

In order to achieve the abovementioned objectives of the present invention, the adopted technical means and effects are described below by illustrating embodiments with drawings.

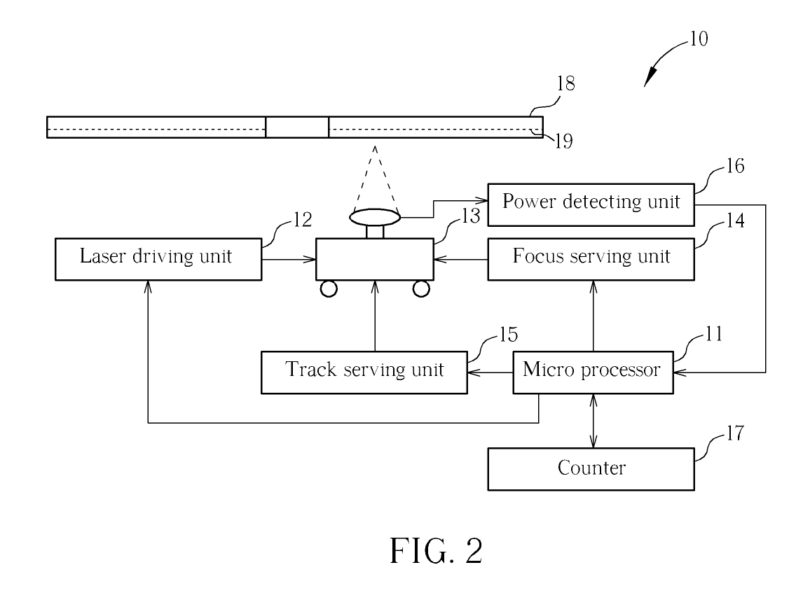

Please refer to FIG. 2 showing an optical disc drive 10 tested by the present invention. The optical disc drive 10 comprises a micro processor 11, a laser driving unit 12, an optical pickup head 13, a focus serving unit 14, a track serving unit 15, a power detecting unit 16, and a counter 17. During the test process, the micro processor 11 of the optical disc drive 10 control the laser driving unit 12 to output a driving control signal to make the optical pickup head 13 output a laser beam with a predetermined power according to the driving control signal. Next, the micro processor 11 controls the focus serving unit 14 to drive the optical pickup head 13 to focus the laser beam on a predetermined focus level near a data level 19 of an optical disk 18. The micro processor 11 further controls the track serving unit 15 to drive the optical pickup head 13 to move radially along the optical disk 18 to perform the test. Since the laser beam does not focus on the data level 19 of the optical disk 18 during the test of the present invention, the data is not written to the optical disk 18, and only a virtual writing is performed. The power detecting unit 16 detects an actual output power of the laser beam of the optical pickup head 13 and transmits the actual output power to the micro processor 11 during the test. The micro processor 11 compares the actual output power transmitted by the power detecting unit 16 with the predetermined power of the laser beam outputted by the laser driving unit 12, to determine whether the output power of the laser beam changes. The micro processor 11 controls the counter 17 to accumulate a number of the virtual writing test to determine whether the virtual writing test is finished.

The output power of the laser beam of the optical pickup head 13 driven by the laser driving unit 12 has to be maintained in a certain level, so that data marks written in the optical disk 18 can be correctly read. Only the laser beam of the certain level can form clear and steady data marks in tracks of the optical disk 18 rotating in high speed. On the contrary, when the output power of the laser beam declines, the data marks will be blurred and can not be read correctly. Thus, the present invention utilizes detecting whether the actual output power of the laser beam of the optical pickup head 13 changes during the virtual writing test to determine whether the optical disc drive passes the test. Therefore, the procedures of reading data, determining successful writing, and removing data can be omitted to simplify the test process and reduce the test time. Additionally, the present invention also can determine the output power changes when a difference between the output power and the predetermined power exceeds a threshold, to avoid detection errors of the output power affecting determination accuracy.

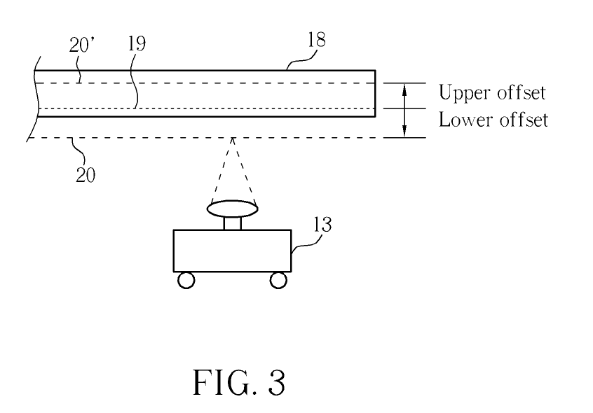

FIG. 3 shows the predetermined focus level during the test of the present invention. The present invention utilizes detecting whether the actual output power of the laser beam changes to determine whether the optical disc drive passes the test, and does not determine whether the written data can be read correctly. Thus, the method for testing the optical disk drive of the present invention can focus the laser beam of the optical pickup head 13 on a predetermined focus level. The predetermined focus level can be offset from the data layer 19 of the optical disk 18 upwardly or downwardly to form an upper offset focus level 20 or a lower offset focus level 20′, so as to perform the virtual writing test. During the test process, the data layer 19 of the optical disk 18 will not be damaged by the laser beam of the optical pickup head 13 with the predetermined power level, and the optical disk 18 can maintain in an original status without affected by the virtual writing test, and thus the optical disk 18 can be used repeatedly to attain the purpose of reducing wear of the optical disk. Moreover, the present invention only outputs and detects the laser beam with the predetermined output power of the laser beam during the virtual writing, and does not actually write data in the data layer of the optical disk when testing the optical disk drive. The method of the present invention also can be applied to an optical disk drive without a writing function. Especially for a lightscribe disk drive which can draw tag pattern on a tag surface of the optical disk, the present invention can make a focus of the lightscribe laser beam offset from the tag surface to perform the virtual writing test, to reduce the test time and the wear of the optical disk.

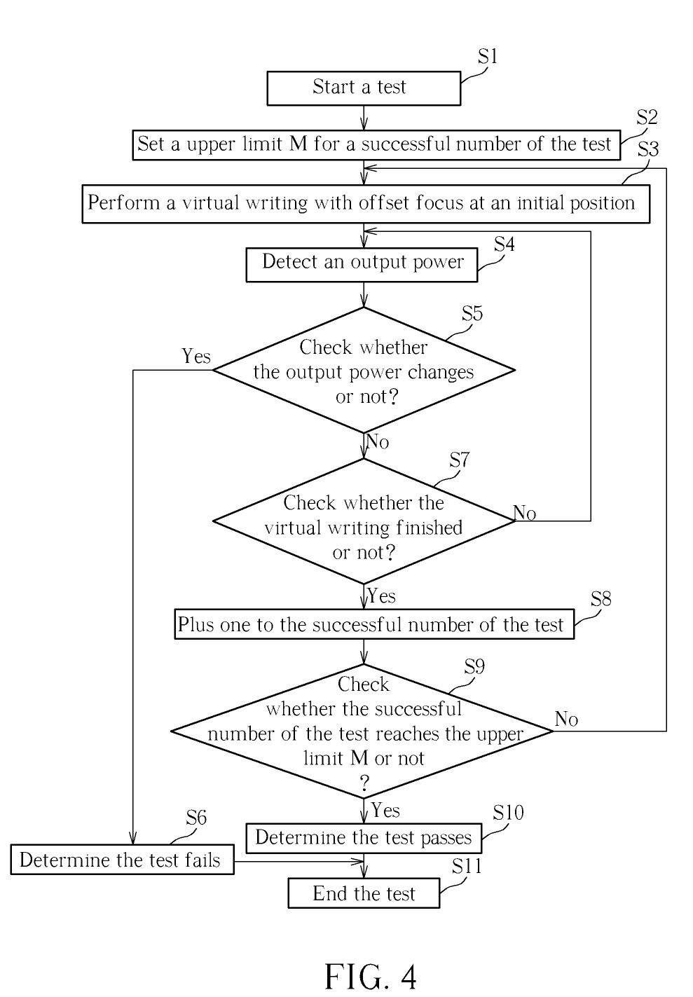

Please refer to FIG. 4. FIG. 4 is a flowchart of a method for testing an optical disk drive of the present invention. The steps of utilizing the virtual writing to test the optical disk drive of the present invention are illustrated as follows. At first, enter Step S1 to start a test for an optical disk drive and put an optical disk into the optical disk drive. In Step S2, reset a counter and setting an upper limit M for a successful number of the test. In Step S3, move an optical pickup head to an initial writing position to virtually write the optical disk with a laser beam with a predetermined power in an upper offset focus level or a lower offset focus level. In Step S4, detect an actual output power of the laser beam of the optical pickup head. In Step S5, check whether the actual output power is different from the predetermined power. If the output power is different from the predetermined power, determine the optical pickup head can not write the optical disk normally and go to Step S6 to determine the test fails, and then go to Step S11 to end the test; if the output power is not different from the predetermined power, go to Step S7 to continue the virtual writing test and check whether the virtual writing is finished. If the virtual writing is not finished, go to Step S4 to continue detecting the actual output power of the laser beam; if the virtual writing is finished, go to Step S8 to plus one to the successful number and go to Step S9 to check whether the successful number of the test reaches the upper limit M. If the successful number does not reach the upper limit M, go to Step S3 to repeat the test; if the successful number reaches the upper limit M, go to Step S10 to determine the test passes and go to Step S11 to end the test.

Thus, the method for testing an optical disk drive of the present invention can make a focus of a laser beam of an optical pickup head offset from a data layer or a label layer of an optical disk to proceed with a virtual writing to avoid writing the optical disk, and check whether the output power of the laser beam of the optical pickup head changes to determine whether the optical disk drive passes the test, so as to simply the test process and reduce the test time and the wear of the optical disk.

Those skilled in the art will readily observe that numerous modifications and alterations of the device and method may be made while retaining the teachings of the invention.

What is claimed is:

1. A method for testing an optical disk drive, comprising:
(1) resetting a successful number of a test and setting an upper limit for the successful number of the test;
(2) proceeding with a virtual writing by a laser beam with a predetermined power;
(3) detecting an output power of the laser beam;
(4) checking whether the output power is different from the predetermined power; if the output power is different from the predetermined power, determine the test fails and go to step (7); if the output power is not different from the predetermined power, go to step (5);
(5) checking whether the virtual writing is finished; if the virtual writing is not finished, go to step (3); if the virtual writing is finished, plus one to the successful number and go to step (6);
(6) checking whether the successful number reaches the upper limit; if the successful number does not reach the upper limit, go to step (2); if the successful number reaches the upper limit, determine the test passes and go to step (7);
(7) ending the test.

2. The method of claim 1, wherein the virtual writing focuses the laser beam on a predetermined focus level.

3. The method of claim 2, wherein the predetermined focus level makes a focus of the laser beam offset from a data layer of the optical disk.

4. The method of claim 3, wherein the predetermined focus level makes the focus of the laser beam offset from the data layer of the optical disk downwardly.

5. The method of claim 3, wherein the predetermined focus level makes the focus of the laser beam offset from the data layer of the optical disk upwardly.

6. The method of claim 3, wherein the predetermined focus level is positioned near the data layer.

7. The method of claim 1, wherein the predetermined focus level makes a focus of the laser beam offset from a tag surface of the optical disk.

8. The method of claim 1, wherein when a difference between the output power and the predetermined power exceeds a threshold, the step (4) determines the output power is different from the predetermined power.

9. The method of claim 1, wherein the optical disk drive does not have a writing function.
